(19) United States
(12) Patent Application Publication
(10) Pub. No.: US 2010/0229697 A1
(43) Pub. Date: Sep. 16, 2010

(54) Screw Holding Type Screwdriver Bit

(76) Inventor: Robert T. Snead, Montrose, CO (US)

Correspondence Address: CROSSLEY PATENT LAW, 236 South Third Street, #287, MONTROSE, CO, 81401, US

(21) Appl. No.: 12/681,372

(22) PCT Filed: Oct. 1, 2008
(86) PCT No.: PCT/US08/78500

§ 371 Date: Apr. 1, 2010

Related U.S. Application Data
(60) Provisional application No. 60/976,657, filed on Oct. 1, 2007.

(51) Int. Cl. B25B 23/10

(52) U.S. Cl. 81/452

(57) ABSTRACT

A screw holding type screwdriver bit which permits the tip end of a screwdriver bit to capture a fastener head thereby allowing the fastener to be pulled while simultaneously turning the fastener, thus creating the resistance necessary to tighten the fastener. The bit provides a tip end, a shank having a slot, a compression spring, a grip having a start loop and a finish loop engaging opposite sides of the tip end and a span slidingly engaging a top end of the slot, and a retainer clip having a front end slidingly engaging the length of the compression spring and a rear end pivotally engaging a lower end of the slot.

I claim benefit of my U.S. Provisional Application No. 60/976,657 filed on Oct. 1, 2007

### BACKGROUND OF THE INVENTION

The installation of a mechanical fastener using a regular or electric screwdriver drill or driver to aid in the installation is often problematic because a pulling pressure must be applied, while also pushing to engage the tip end of the screwdriver bit in order to tighten a fastener in place. The process is both time-consuming and difficult. The present screw holding type screwdriver bit solves the foregoing problems by providing a modified screwdriver bit which permits the tip end of a screwdriver bit to capture a fastener head thereby allowing the fastener to be pulled while simultaneously turning the fastener, thus creating the resistance necessary to tighten the fastener.

### SUMMARY OF THE INVENTION

The present screw holding type screwdriver bit is a modified screwdriver bit expediting installation of fasteners by holding the tip end of the modified screwdriver bit onto a fastener while simultaneously pulling on the fastener to tighten the fastener when utilizing a power drill or driver.

As such, the general purpose of the improved screw holding type screwdriver bit which has all of the advantages of the prior art screw holding type screwdriver bits and many novel features that result in an improved screw holding type screwdriver bit which is not anticipated, rendered obvious, suggested, or even implied by the prior art, either alone or in combination thereof.

Thus has been broadly outlined the more important features of the improved screw holding type screwdriver bit so that the detailed description thereof that follows may be better understood and in order that the present contribution to the art may be better appreciated.

The objects, features and advantages of the improved screw holding type screwdriver bit will be readily apparent to those of ordinary skill in the art upon reading the following detailed description of presently preferred, but nonetheless illustrative, embodiments of the improved screw holding type screwdriver bit when taken in conjunction with the accompanying drawings. In this respect, before explaining the current embodiments of the improved screw holding type screwdriver bit in detail, it is to be understood that the invention is not limited in its application to the details of construction and arrangements of the components set forth in the following description or illustration. The invention is capable of other examples and of being practiced and carried out in various ways. It is also to be understood that the phraseology and terminology employed herein are for purposes of description and should not be regarded as limiting.

Those skilled in the art will appreciate that the concept of this disclosure may be readily utilized as a basis for the design of other structures, methods, and apparatus for carrying out the several purposes of the improved screw holding type screwdriver bit. It is therefore important that the claims be regarded as including such equivalent constructions insofar as they do not depart from the spirit and scope of the present invention.

Objects of the improved screw holding type screwdriver bit, along with various novel features that characterize the invention are particularly pointed out in the claims forming a part of this disclosure. For better understanding of the improved screw holding type screwdriver bit, its operating advantages and specific objects attained by its uses, refer to the accompanying drawings and description.

### BRIEF DESCRIPTION OF THE DRAWINGS

FIG. 1 is a right side elevation view.

FIG. 2 is a right side isometric view.

FIG. 3 is an enlarged right side elevation view.

FIG. 4 is an enlarged top plan view.

FIG. 5 is a front elevation view.

FIG. 6 is a top plan view.

FIG. 7 is a left side isometric view.

FIG. 8 is a right side elevation view of the individual components.

FIG. 9 is a right side isometric view illustrating a grip inserted through a shank slot.

### DETAILED DESCRIPTION OF THE DRAWINGS

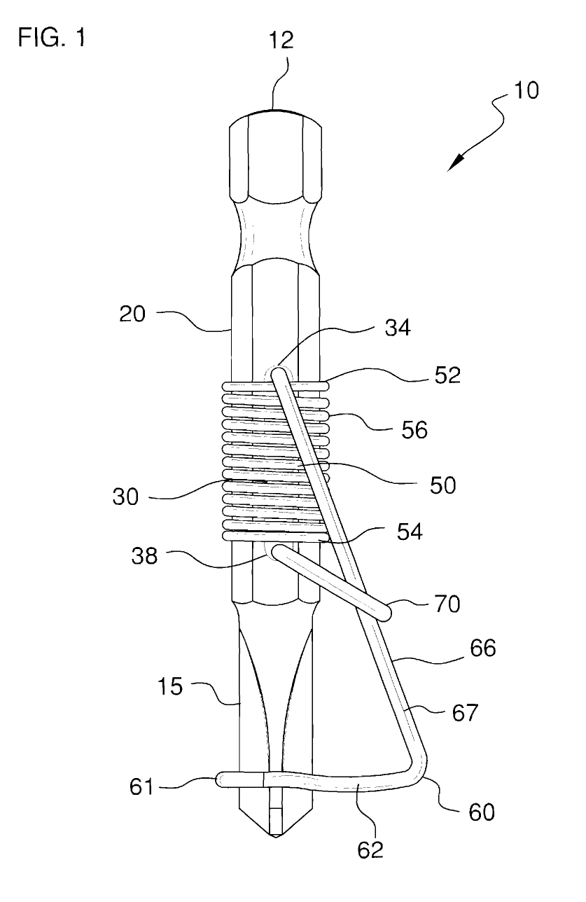

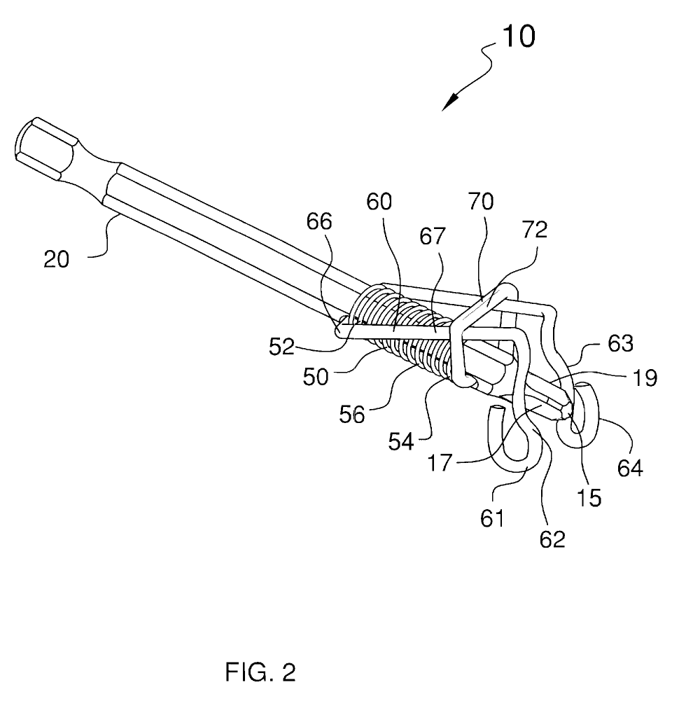

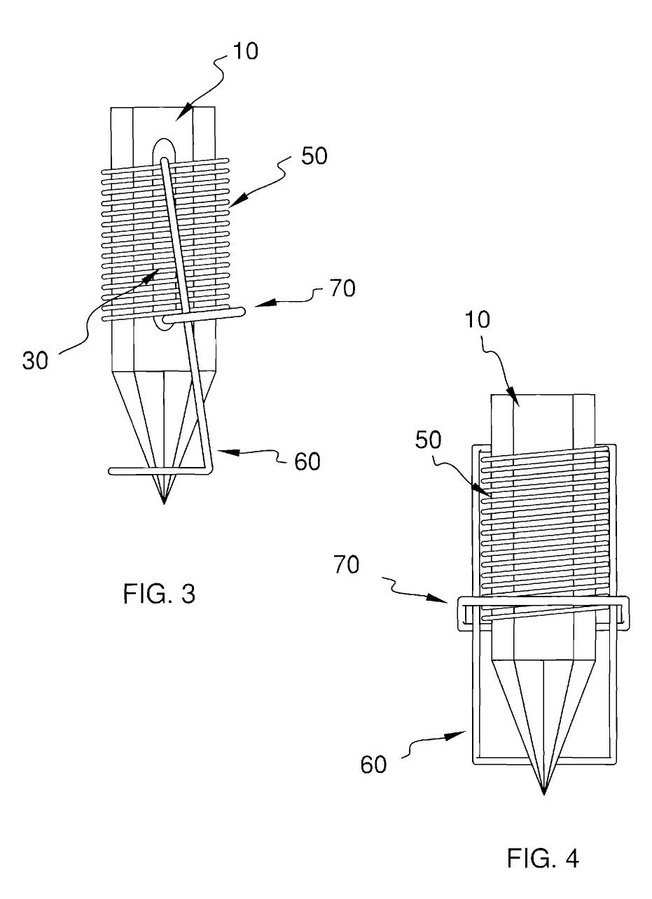

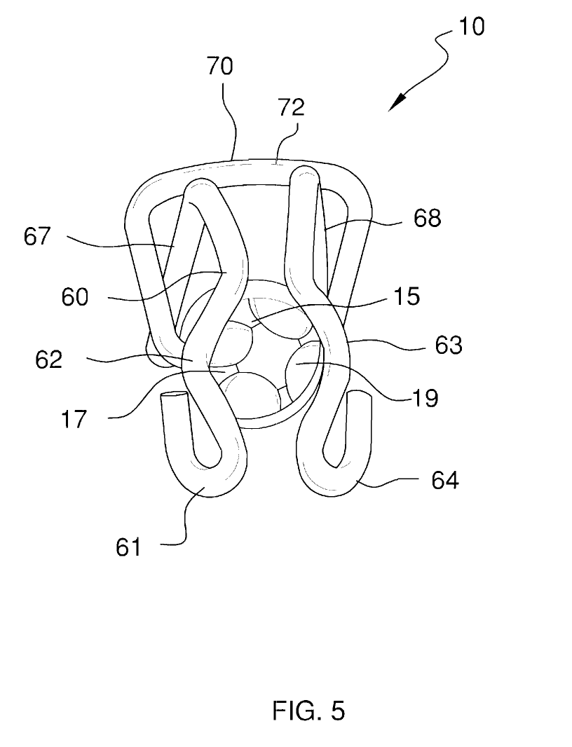

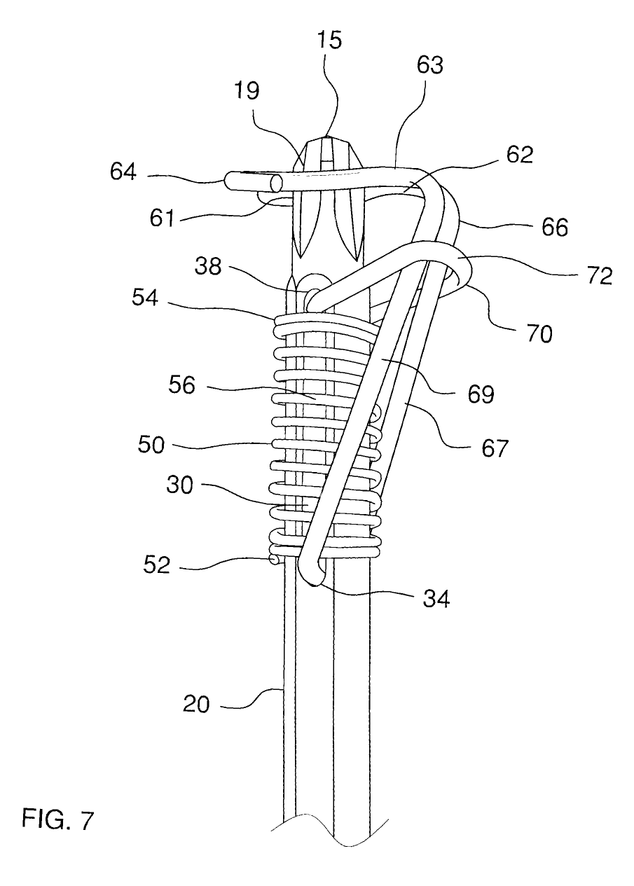

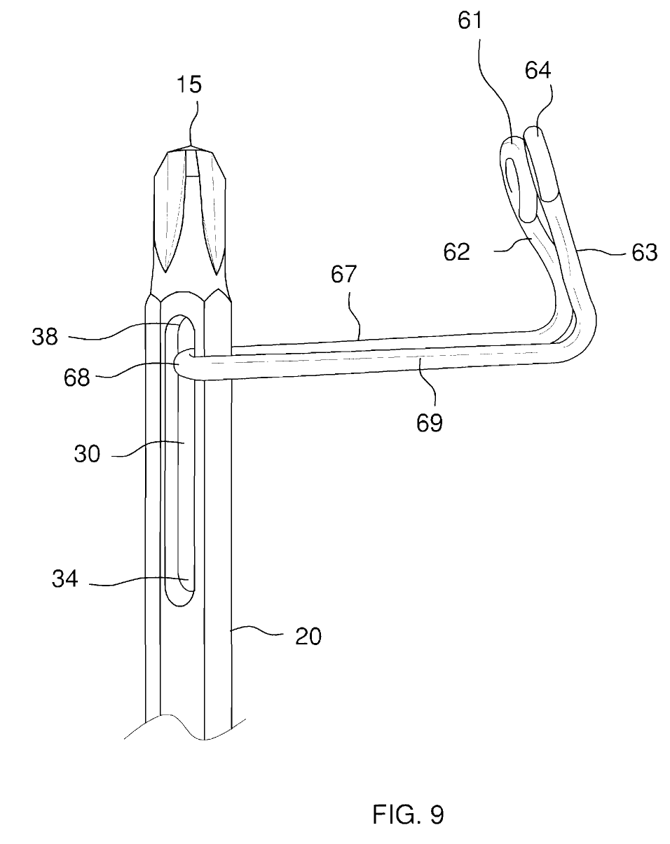

With reference now to the drawings, and in particular FIGS. 1 through 9 thereof, examples of the employing the principles and concepts of the present screw holding type screwdriver bit, generally designated by the reference number 10, will be described.

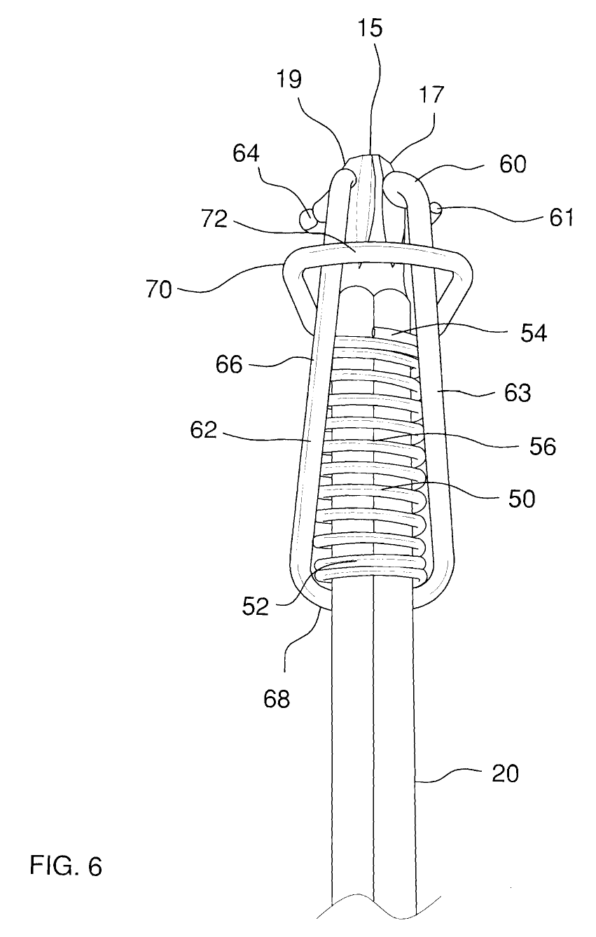

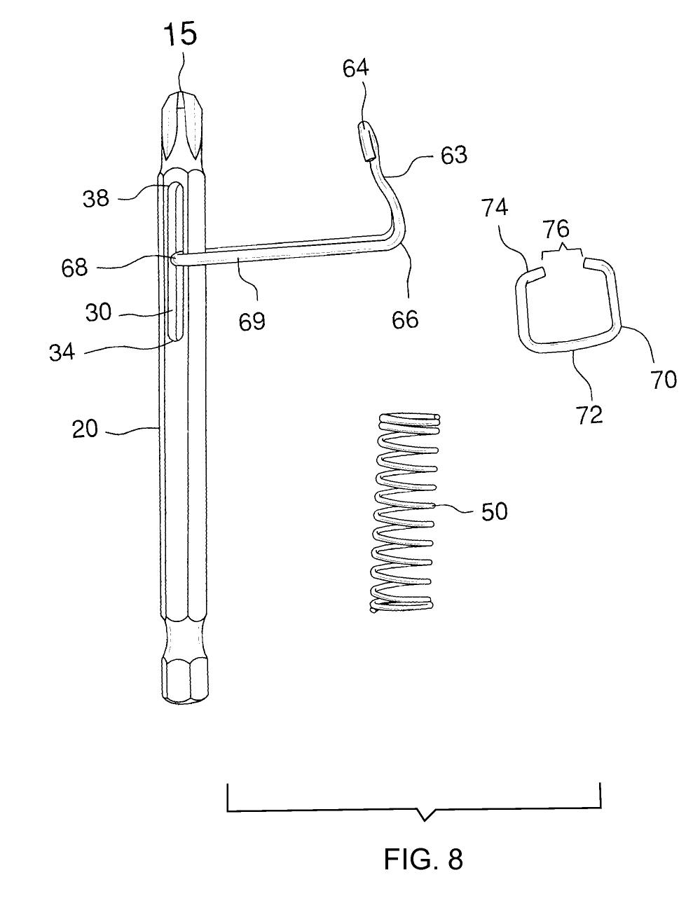

Referring to FIGS. 1 through 9, the present screw holding type screwdriver bit 10 is a modified screwdriver bit tip end expediting the installation of a mechanical fastener by holding the tip end of the modified screwdriver bit onto the fastener while pulling on the fastener thereby creating resistance to tighten the fastener in place. The bit 10 has a shank 20. The shank 20 has an engagement end 12 and a tip end 15. The tip end 15 removably engages a fastener head. The tip end 15 has a first edge 17 and an opposite second edge 19. The shank 20 has a slot 30 centered therein and running continuously therethrough. The slot 30 has a top end 34 and an opposite lower end 38. The slot 30 may be obround as illustrated. The present driver 10 also provides a wire compression spring 50 having a distal end 52, a proximal end 54, and a length 56 between the distal end 52 and the proximal end 54. The spring 50 length 56 encircles the shank 20 circumference around the slot 30. The compression spring 50 may be placed into an extended position as illustrated in FIG. 8 or into a contracted position as illustrated in FIGS. 1 and 6. A grip 60, formed of a continuous length of heavy cylindrical wire, has a primary end 62 having a start loop 61, a secondary end 63 having a finish loop 64, and a span 66 between the primary end 62 and the secondary end 63. The primary end and secondary end 63 are parallel to each other and are perpendicular to the shank 20. The span 66 has a first section 67, a second section 69 parallel to the first section 67, and a center section 68 between and perpendicular to the first section 67 and the second section 69. The grip 60 start loop 61 engages the tip end 15 first edge 17 and the finish loop 64 engages the tip end 15 second edge 19. The span first section and second section each run at about a 45-degree angle to the shank 20, while the center section 68 removably and slidingly engages the slot 30 top end 38. The grip 60 selectively exerts pressure on the compression spring 50 thereby placing the spring 50 into the contracted position. A rectangular retainer clip 70 is provided to secure the compression spring 50 in a contracted position. The retainer clip 70 has front end 72 and a rear end 74. The retainer clip 70 is formed of heavy cylindrical wire. A gap 76 is centered in the rear end 74, thereby allowing the rear end 74 of the retainer clip 70 to be inserted into the slot 30. The front end 72 of the retainer clip 70 selectively slidingly engages the length 56 of the compression spring 50 while the rear end 74 pivotally engages the slot lower end thereby placing the compression spring 50 into a contracted position.

### Use:

To use the screw holding type screwdriver bit 10, a user inserts the tip end 15 of the modified screwdriver bit 10 into a fastener head with the retainer clip in position to exert pressure on the grip 60 thereby placing the compression spring 50 into a contracted position. The screw holding type screwdriver bit 10 steadies the fastener by placing pressure on the fastener head while also pulling on the fastener to tighten the fastener when using the bit 10 in combination with a power drill or driver. To remove the bit 10 from the fastener, the user pushes the retainer clip 70 upwardly and away from the grip 60, thereby releasing the tension on the compression spring 50.

With respect to the above description then, it is to be realized that the optimum dimensional relationships for the parts of the present apparatus, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Directional terms such as “front”, “back”, “in”, “out”, “downward”, “upper”, “lower”, and the like may have been used in the description. These terms are applicable to the examples shown and described in conjunction with the drawings. These terms are merely used for the purpose of description in connection with the drawings and do not necessarily apply to the position in which the present invention may be used.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A screw holding type screwdriver bit comprising:
a shank having a tip end and an opposite engagement end;
a slot having a top end and an opposite lower end, the slot centered and running continuously through the shank;
a spring having a distal end, an proximal end, and a length between the distal end and the proximal end, the spring length completely encircling the shank circumference around the slot;
a grip slidingly secured within the slot ; and
wherein the compression spring is selectively placed into an extended position and into a contracted position; and
further wherein the tip end removably engages a fastener head.

2. The bit of claim 1 further comprising a retainer clip movably contained within the slot, wherein the clip selectively restrains movement of the grip.

3. The bit of claim 1 wherein the slot is obround.

4. The bit of claim 1 wherein the grip and the retainer clip are formed of heavy cylindrical wire.

5. The bit of claim 2 wherein the grip and the retainer clip are formed of heavy cylindrical wire.
